(19) United States
(12) Patent Application Publication
(10) Pub. No.: US 2008/0223693 A1
(43) Pub. Date: Sep. 18, 2008

(54) ARRANGEMENT FOR MOVING A CARRIER IN A CHAMBER, IN PARTICULAR A VACUUM CHAMBER

(76) Inventors: Edgar Haberkorn, Jossgrund (DE); Susanne Schlaefer, Buedingen (DE)

Correspondence Address: FISH & RICHARDSON P.C., PO BOX 1022, MINNEAPOLIS, MN, 55440-1022, US

(21) Appl. No.: 12/039,606

(22) Filed: Feb. 28, 2008

(30) Foreign Application Priority Data
Mar. 13, 2007 (EP) 07104010.9

(51) Int. Cl. B65G 35/00; B65G 13/02

(52) U.S. Cl. 198/619; 198/786

(57) ABSTRACT

An arrangement for moving a carrier within a vacuum chamber is described. This carrier is formed in the shape of a plate and is supported with its narrow-side lower edge on rollers driven by a drive system. As a drive system uses a magnetic coupling which is disposed partially within the vacuum chamber and partially outside of the vacuum chamber. With the aid of a force acting in the vertical direction the two components of the magnetic coupling can be displaced relative to one another. In addition, horizontal displacement of the carrier is also possible.

### BACKGROUND

The invention relates to substrate transfer in a chamber.

In vacuum coating installations operating according to the PECVD principle (PECVD=Plasma Enhanced Chemical Vapor Deposition) the coating takes place directly via the gas introduced into the installation and ionized by a source. A plasma burns between the source and a substrate or a back electrode disposed behind the substrate.

The substrates are often fastened on a carrier which is moved on rollers through the vacuum coating installation. These rollers are moved by drive systems preferably located outside of the vacuum coating installation such that no contaminations occur in the coating installation.

A driving arrangement for a shaft located in a chamber is already known (US 2005/0206260 A1). This shaft is driven via a magnetic coupling by means of a motor located outside of the chamber.

Moreover, a transport arrangement for substrates in vacuum coating installations with several transport rollers is known (DE 103 28 273 A1). In this arrangement the drive as well as also the transport rollers are located in the evacuated region of the coating installation.

A process chamber is furthermore known which comprises a transport system for workpieces (GB 2 171 119 A). This transport system includes cylinders driven by a magnetic coupling. The magnetic coupling serves herein for switching between two sets of transport rollers disposed on a lift within the chamber.

Further known is an arrangement for moving mounting parts in vacuum installations, which comprises a connection element within a volume, which element is partially comprised of a magnetic material, wherein outside of the volume also a magnetic material is disposed which is exclusively in contact with the inner magnetic material via frictional connection (DE 102 27 365=EP 1 387 473 A2).

In a known method for treating laminar substrates, such as silicon disks, in vertical orientation for the production of micro-electrical structural elements, driving rollers are provided which are pressed onto three sites of a circular silicon disk (U.S. Pat. No. 6,251,551 B1). This silicon disk can be rotated about its axis by means of the driving rollers. However, the linear further transporting of the silicon disk takes place with the aid of a conveyor belt.

For the rotation movement of a plate-shaped and circular carrier it is known to provide several rollers which engage on the margin of the carrier (JP 2002 110763 A). However, the linear movement of the carrier takes place via rails.

A magnetic carrier arrangement with a spiral-magnetic coupling is disclosed in US 2002/0060134 A1. This arrangement, however, does not provide a lifting mechanism for rollers.

EP 1 648 079 A2 describes a system for the transmission of movement between objects separated by a wall. This system is not suitable for the transport of carriers.

Lastly, a vacuum coating installation with transport rollers for the transport of a laminar substrate is known, which comprises a drive system located outside of the vacuum coating installation and at least one magnetic coupling between the drive and at least one transport roller (not previously published European Patent Application EP 1 870 487).

### SUMMARY

The devices described herein address the problem of automatically moving objects within a chamber in at least one direction.

This problem is solved using an arrangement of a carrier in the shape of a plate and linearly movable by driving rollers, where the driving rollers are moved by a lifting mechanism toward and away from a narrow side of a plate shaped carrier.

Consequently, an arrangement for moving a carrier within a vacuum chamber is described. This carrier can be formed in the shape of a plate and disposed with its narrow-side lower edge on rollers driven by a drive system. A magnetic coupling, which is located partially within the vacuum chamber and partially outside of the vacuum chamber, can serve as the indirect drive. A component of the magnetic coupling can be located outside of the vacuum chamber being driven by a motor. With the aid of a force acting in the vertical direction, the two components of the magnetic coupling can be displaced relative to one another. Horizontal displacement of the carrier is, in addition, also possible.

One advantage attained with the arrangement is that carriers within a vacuum coating installation can be separated from driving rollers bearing the carriers. A further advantage can be that the carriers can also be displaced laterally.

### BRIEF DESCRIPTION OF THE FIGURES

An example embodiment is depicted in the drawing and will be described in further detail in the following. The drawings depict:

FIG. 1 an overall view of a process chamber,

FIG. 2 a longitudinal section A-A through the process chamber of FIG. 1,

FIG. 3 an enlarged partial representation from FIG. 2 in a first position,

FIG. 4 an enlarged partial representation from FIG. 2 in a second position and

FIG. 5 a portion of a longitudinal section B-B through the process chamber of FIG. 1.

### DETAILED DESCRIPTION

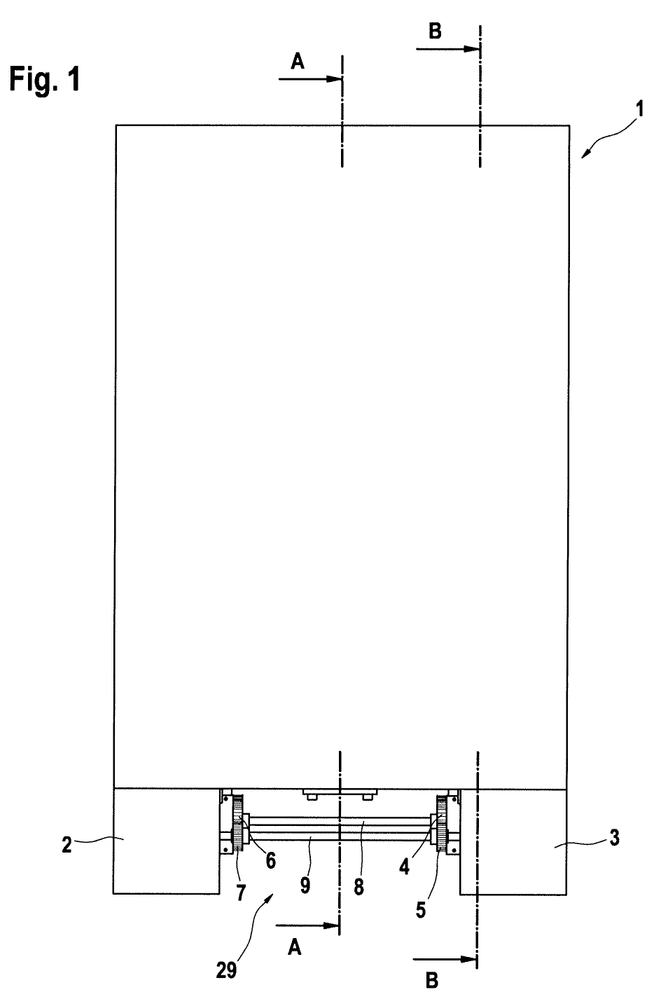

FIG. 1 shows a process chamber 1 in side view. Besides this process chamber 1 can be located further, not shown, chambers. These chambers can be process and/or buffer chambers.

The process chamber 1 rests on feet 2, 3 between which a gearing 29, with toothed wheels 4, 5; 6, 7 and counter shafts 8, 9, is located.

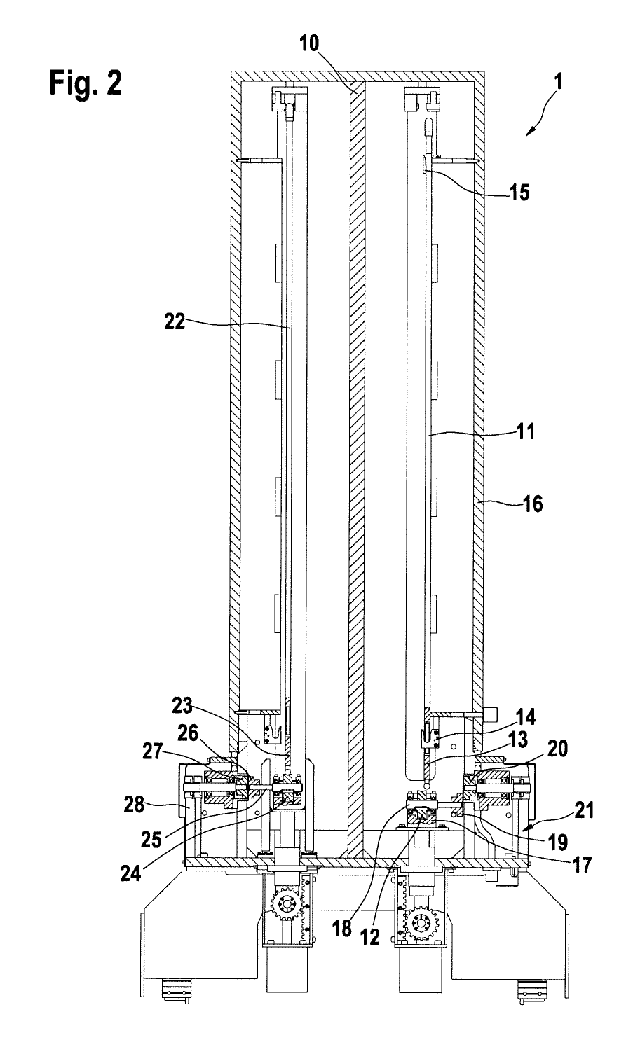

FIG. 2 shows a section A-A through the process chamber 1. It can be seen that the process chamber is divided into two halves by an intermediate wall 10. In the one half is located a carrier 11, which can move into the plane of the drawing and specifically on guidance rollers, of which in FIG. 2 only two guidance rollers 12, 24 are shown. The lower end 13 of carrier 11 in the representation of FIG. 2 has just decoupled from roller 12 and been moved by means of hooks 14, 15 and a (not shown) drive in the direction toward a wall 16. Behind the feet 2, 3 are located lifting pistons, which will be discussed later and which, however, are not evident in FIG. 1. Referring back to FIG. 1, a gearing 29 is only necessary when utilizing two lifting cylinders in order to make the lifting uniform. A transport beam 17 bears a shaft 18, which extends through the guidance roller 12 and is connected with one half 19 (or inner component 19) of a magnetic coupling, which is located in the process chamber 1, and is located opposingly with a second half 20 (or outer component 20) of the magnetic coupling, which is provided outside of the process chamber 1. The drive of this second half 20 takes place via a belt drive 21. In embodiments, the halves 19, 20 of the magnetic coupling located opposite to one another have smooth faces capable of gliding past one another.

Referring to FIG. 2, in the left half of process chamber 1 separated by the intermediate wall 10 is shown a further carrier 22 whose movement is such that it egresses from the plane of the drawing. The end 23 of this carrier 22 rests in a guidance roller 24, through which is guided a shaft 25, which, in turn, is guided through the component 26 of a magnetic coupling that is located in the process chamber 1, whose component 27 located outside of process chamber 1, is driven by a belt drive 28.

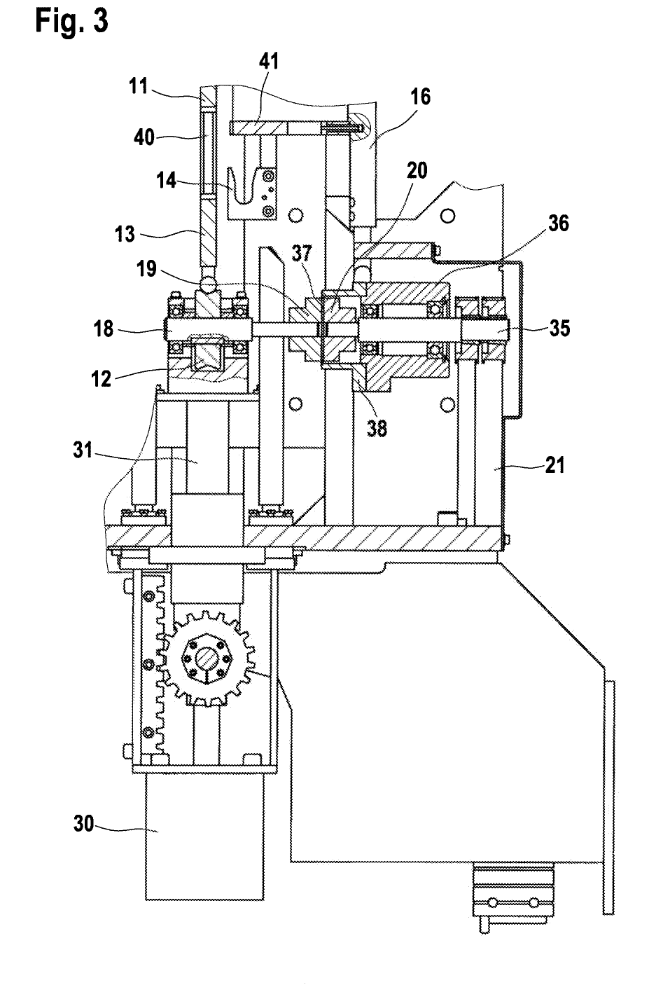

FIG. 3 shows an enlarged representation of a partial region of FIG. 2. Evident is herein again the carrier 11 with its lower end 13, which now rests in guidance roller 12. In order for the lower end 13 to be guided out of the roller 12, a pneumatic cylinder 30 capable of moving a lifting piston 31 upwardly and downwardly is provided. In the position shown in FIG. 3 the lifting piston 31 is moved upwardly, whereby the transport beam 17 (FIG. 2), the guidance roller 12, and with it the shaft 18 and the inner component 19 of the magnetic coupling, are also moved upwardly. The inner component 19 of the magnetic coupling is now directly opposite the outer component 20 of the magnetic coupling. A driving shaft 35 supported in a bearing 36 and bearing the outer magnet 20 and driven by the belt drive 21, is stationarily connected with wall 16. A thin diaphragm 37 separates the interior of the process chamber 1 from the atmosphere. The diaphragm 37 is fitted into a sleeve 38 or into a portion of this sleeve 38.

In the position shown in FIG. 3, in which the carrier 11 is moved into the process chamber 1, the hook 14 is located outside of carrier 11, i.e., it does not extend into an aperture 40 of the carrier in order to move it in the direction toward the side wall 16 of process chamber 1. The hook 14 is not fastened on a contact frame 41 but rather on a leadthrough which carries out a horizontal movement. This leadthrough is not visible in FIG. 3.

When the driving shaft 35 is rotated by the belt drive 21, the outer component 20 of the magnetic coupling located at atmospheric pressure also rotates. Its magnetic field penetrates through the nonmagnetic or nonmagnetizable diaphragm 37 supported in the sleeve 38 or in a portion of this sleeve 38, and entrains the inner component 19 of the magnetic coupling located in the process chamber 1. The shaft 18, and with it the guidance roller 12, thereby rotate. Since in the guidance roller 12 the lower end of the carrier 11 is supported, the carrier 11 moves into the plane of drawing.

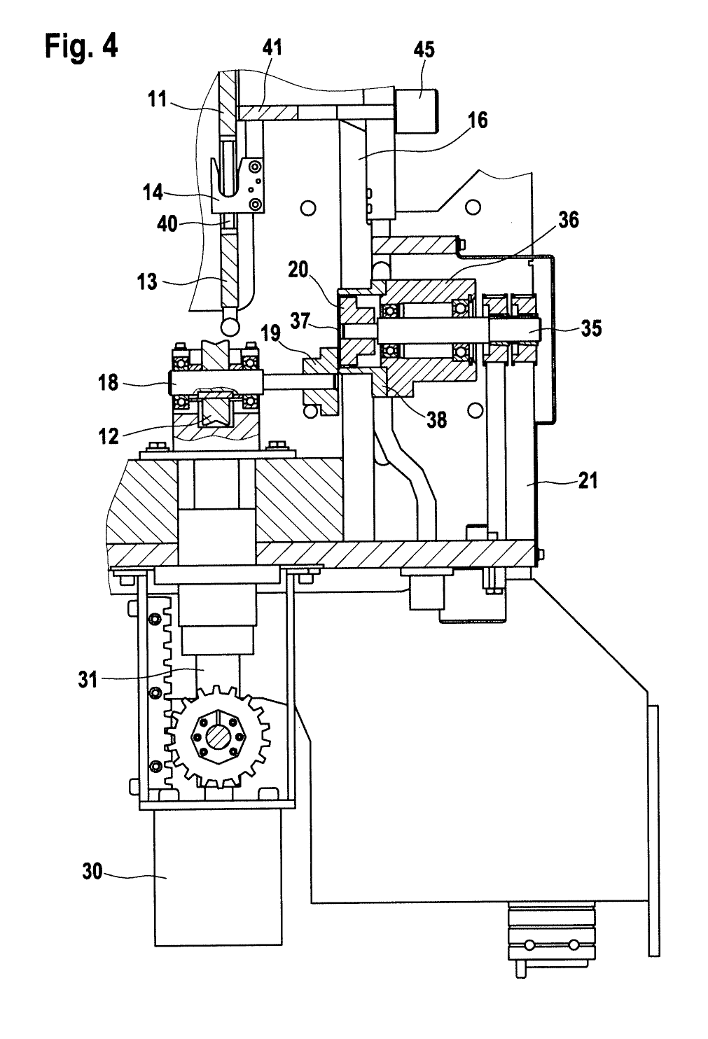

FIG. 4 shows once again an enlarged representation of a portion of the arrangement depicted in FIG. 2, and specifically in the position of FIG. 2, in which the carrier 11 is not moved into the plane of drawing, but rather in the direction toward wall 16 of process chamber 1. In order to reach this position, hook 14, moved by a drive 45 horizontally toward the left, extends into the aperture 40 of carrier 11. The lifting cylinder is now lowered such that carrier 11 is suspended in hook 14. The carrier 11 can now be moved horizontally by means of hook 14, of a not shown support, and of drive 45. The two components 19, 20 of the magnetic coupling are herein vertically offset with respect to one another.

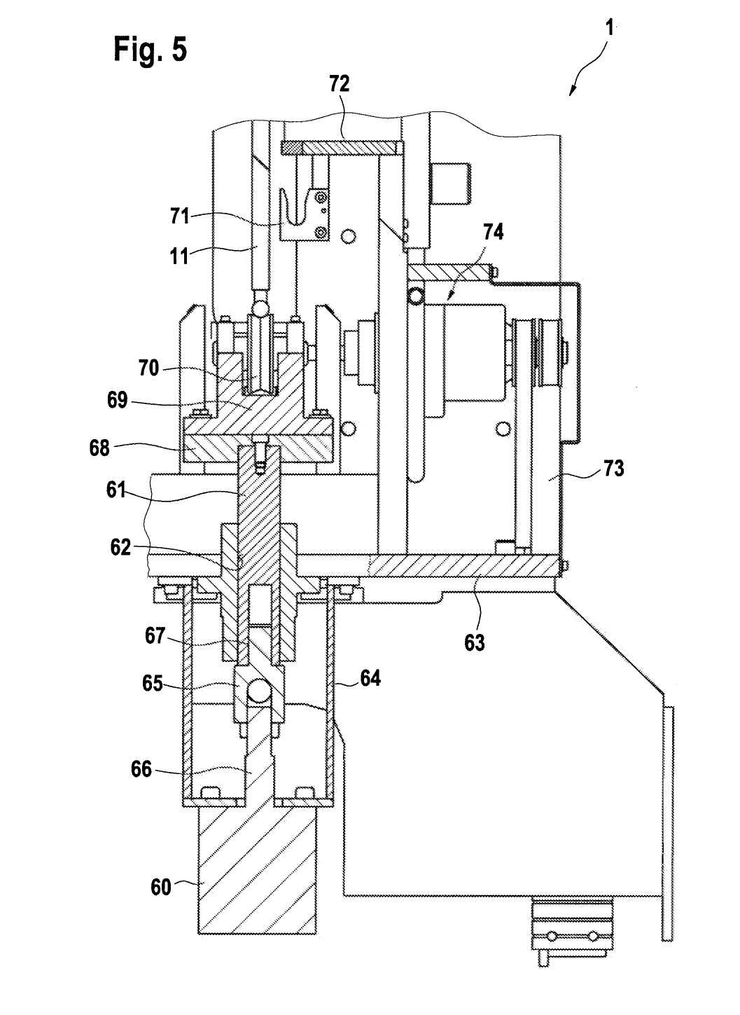

FIG. 5 shows a segment from a longitudinal section B-B, with only the right carrier 11 being evident. The longitudinal section of FIG. 5 extends through a lifting cylinder 60 and a lifting piston 61 connected therewith. A leadthrough 62 is through the bottom 63 of process chamber 1. Flanged onto the bottom 63 is a holder 64, in which is located a coupling part 65, which shows a piston rod 66 of the lifting cylinder 60 with a portion 67 of the lifting piston 61. The lifting cylinder 60 is a pneumatic cylinder which with the coupling part 65 is screwed into the piston 61.

The lifting piston 61 is connected via a support 68 with a transport beam 69 in which a guidance roller 70 can roll. At a spacing from carrier 11 can be seen a prong 71 fastened on a (not shown) support, which is connected with a drive, not shown here, located on the outside of wall 16. A belt drive 73 drives a magnetic coupling 74, which, in turn, rotates the guidance roller 70.

It is feasible to provide two lifting pistons for each transport beam 69, one at the front and one at the rear end of the transport beam. It is, however, also possible to provide only one lifting piston which engages in the center of the transport beam 69. The carrier 11 is pressed out of a contact frame 72 in order to ensure a defined parallel distance between plasma source and substrate. The contact frame serves, in addition, for delimiting the plasma volume and for the grounding of the carrier back electrode.

1. An arrangement for moving a plate-shaped carrier in a vacuum chamber, comprising:
a driving roller configured to linearly move the plate-shaped carrier; and
a lifting mechanism configured to move the driving roller toward and away from a narrow side of the plate-shaped carrier.

2. The arrangement as claimed in claim 1, wherein the driving roller rests on a transport beam and the lifting mechanism is connected with the transport beam.

3. The arrangement as claimed in claim 1, wherein the driving roller is coupled with a magnetic coupling.

4. The arrangement as claimed in claim 3, wherein the magnetic coupling includes a first component located within the chamber and a second component located outside of the chamber.

5. The arrangement as claimed in claim 4, wherein the first component and the second component of the magnetic coupling are located symmetrically opposite one another in a first position of the carrier and, in a second position of the carrier, are displaced in the vertical direction with respect to one another.

6. The arrangement as claimed in claim 1, wherein the carrier includes an aperture.

7. The arrangement as claimed in claim 6, wherein a hook is provided capable of extending through the aperture and supporting the carrier.

8. The arrangement as claimed in claim 7, wherein the carrier includes a pin on which the hook engages.

9. The arrangement as claimed in claim 7, wherein the hook is movable perpendicularly to a main surface of the carrier.

10. The arrangement as claimed in claim 9, wherein a drive for the movement of the hook is provided outside of the chamber.
